(19) United States
(12) Patent Application Publication
(10) Pub. No.: US 2015/0004427 A1
(43) Pub. Date: Jan. 1, 2015

(54) LEAD-FREE SOLDER COMPOSITIONS

(71) Applicant: HONEYWELL INTERNATIONAL INC., Morristown, NJ (US)

(72) Inventors: Jianxing Li, Spokane, WA (US); Michael R. Pinter, Spokane, WA (US); David E. Steele, Spokane, WA (US)

(21) Appl. No.: 14/460,844

(22) Filed: Aug. 15, 2014

Related U.S. Application Data
(63) Continuation of application No. 13/586,074, filed on Aug. 15, 2012.
(60) Provisional application No. 61/524,610, filed on Aug. 17, 2011.

(51) Int. Cl. B23K 35/28; C22C 18/04; C22C 1/02

(52) U.S. Cl. CPC B23K 35/282; C22C 1/02; C22C 18/04
USPC 428/544; 420/519; 420/516; 75/663

(57) ABSTRACT

A solder may include zinc, aluminum, magnesium and gallium. The zinc may be present in an amount from about 82% to 96% by weight of the solder. The aluminum may be present in an amount from about 3% to about 15% by weight of the solder. The magnesium may be present in an amount from about 0.5% to about 1.5% by weight of the solder. The gallium may be present in an amount between about 0.5% to about 1.5% by weight of the solder.

### CROSS-REFERENCE TO RELATED APPLICATION

This application claims priority to Provisional Patent Application No. 61/524,610, filed Aug. 17, 2011, which is herein incorporated by reference in its entirety.

### TECHNICAL FIELD

The disclosure relates to solder materials and more particularly to solder materials that are free or substantially free of lead.

### BACKGROUND

Solder materials are used in the manufacture and assembly of a variety of electromechanical and electronic devices. In the past, solder materials have commonly included substantial amounts of lead to provide the solder materials with desired properties such as melting point, wetting properties, ductility and thermal conductivities. Some tin-based solders have also been developed. More recently, there have been attempts at producing lead-free and tin-free solder materials that provide desired performance.

### SUMMARY

In some embodiments, a solder composition may include about 82 to 96 weight percent zinc, about 3 to about 15 weight percent aluminum, about 0.5 to about 1.5 weight percent magnesium, and about 0.5 to about 1.5 weight percent gallium. In some embodiments, the solder composition may include about 0.75 to about 1.25 weight percent magnesium, and about 0.75 to about 1.25 weight percent gallium. In other embodiments, the solder composition may include about 1.0 weight percent magnesium, and about 1.0 weight percent gallium. In still further embodiments, the solder composition may include about 82 to 96 weight percent zinc, about 3 to about 15 weight percent aluminum, about 0.5 to about 1.5 weight percent magnesium, about 0.5 to about 1.5 weight percent gallium, and about 0.1 to about 2.0 weight percent tin.

The solder composition may include a dopant. In some embodiments, the solder composition includes about 0.5 weight percent or less of a dopant. In other embodiments the dopant includes indium, phosphorous, germanium, copper or combinations thereof.

In some embodiments, the solder composition may be free of lead. In other examples, the solder composition may be free of tin.

In some embodiments, the solder composition may be a solder wire. In still other embodiments, the composition may be a solder wire with a diameter of less than about 1 millimeter.

In other embodiments of the current disclosure, a method of forming a phosphorous doped solder is provided. The method may include producing a melt under positive pressure with an inert gas, and forming the melt into a billet. The melt can include a solder material and phosphorus in an amount between about 10 ppm to about 5000 ppm. In some embodiments, the solder material includes at least one member selected from the group consisting of zinc, aluminum, bismuth, tin, copper and indium. In still other embodiments, the method includes an additional step of bubbling an inert gas through the melt between the producing and forming steps.

While multiple embodiments are disclosed, still other embodiments of the present invention will become apparent to those skilled in the art from the following detailed description, which shows and describes illustrative embodiments of the invention. Accordingly, the detailed description is to be regarded as illustrative in nature and not restrictive.

### BRIEF DESCRIPTION OF THE DRAWINGS

FIG. 1 shows the experimental setup for a high angle breakage rate test.

FIG. 2 shows the experimental setup for a low angle breakage rate test.

FIG. 3 shows thermal analysis of Sample 34 in Example 2.

FIG. 4 shows thermal analysis of Sample 35 in Example 2.

### DETAILED DESCRIPTION

Solder compositions are fusible metal and metal alloys used to join two substrates or workpieces and have melting points below that of the workpieces. A solder composition, such as those used for die attach applications in the semiconductor industry, may be provided in many different forms, including but not limited to, bulk solder products, solder pastes and solder wires.

A solder paste can be a fluid or putty-like material that may be applied to the substrate using various methods, including but not limited to printing and dispensing, such as with a syringe. Example solder paste compositions may be formed by mixing powdered metal solder with a flux, a thick medium that acts as a temporary adhesive. The flux may hold the components of the solder paste together until the soldering process melts the powdered solder. Suitable viscosities for a solder paste may vary depending on how the solder paste is applied to the substrate. Suitable viscosities for a solder paste include 300,000-700,000 centipoise (cps).

In other embodiments, the solder composition may be provided as a solder wire. Solder wires may be formed by drawing solder material through a die to provide a thin solder wire on a spool. Suitable solder wires may have a diameter less than about 1 millimeter (mm), for example, from about 0.3 to about 0.8 mm. In some embodiments, the solder wire is capable of being rolled or coiled on a spool without breaking into two or more pieces. For example, a solder wire may be rolled on a spool having an inner hub diameter of 51 mm and two outer flanges having diameters of 102 mm. As the wire is rolled on the spool, portions of the wire closest to the inner hub are coiled into a spool having an effective diameter of approximately 51 mm. As additional wire is rolled on the spool, the effective diameter of the spool increases due to the wire and the effective diameter of the spool after a plurality of coils of wire are formed on the inner hub may be closer to 102 mm than to 51 mm.

Regardless of form, a solder composition can be evaluated on its solidus temperature, melting temperature range, wetting property, ductility, and thermal conductivity. The solidus temperature quantifies the temperature at which the solder material begins to melt. Below the solidus temperature, the solder material is completely solid. In some embodiments, the solidus temperature may be around 300° C. to allow step soldering operations and to minimize thermal stress in the end use device.

The melting temperature range of a solder composition is defined by the solidus temperature and a liquidus temperature. The liquidus temperature quantifies the temperature above which the solder material is completely melted. The liquidus temperature is the maximum temperature in which crystals (e.g., solids material) can coexist with a melt (e.g., liquid material). Above the liquidus temperature, the solder material is a homogeneous melt or liquid. In some embodiments, it may be preferable to have a narrow melting temperature range to minimize the range at which the solder exists in two phases.

Wetting refers to the ability of a solder to flow and wet the surface of a substrate or workpiece. Increased wetting generally provides an increased bond strength between workpieces. Wetting may be measured using a dot wet test.

All solder joints experience reduced solder joint strength in the end device over the device lifetime. A solder with an increased ductility will prolong the device lifetime and is more desirable. A ductile solder may also be desirable in the fabrication of solder wires as described further herein to enable the solder wire to be coiled or rolled onto a spool. Ductility may be measured with a spool bend tester and may include low angle (less than 90°) and high angle (greater than 90°) ductility measurements. Suitable ductility values depend on the end use of the solder material. In some embodiments, suitable solder materials may have a high angle break rate of 0% and a low angle break rate less than 50%, less than 40% or less than 30%.

High thermal conductivity may also be desired for device performance. In some embodiments, the solder material may connect a die to a lead frame. In such embodiments, it may be desirable for the solder to conduct heat into the lead frame. In some examples, high thermal conductivity is particularly desirable for high-power applications. In certain embodiments, a suitable solder material may have a thermal conductivity greater than 20 watts per meter Kelvin (W/m-K). In other embodiments, a suitable solder material may have a thermal conductivity greater than 10 W/m-K or from 10 W/m-K to about W/m-K. In still further embodiments, a suitable solder material has a thermal conductivity as little as 10, 12, 14 W/m-K or as greater as 15, 18, 20 or 25 W/m-K or may be present within any range delimited by any pair of the foregoing values.

A solder material can be lead free. For example a zinc/aluminum based, or bismuth/copper based solder material can be lead free. As used herein, “lead free” refers to solder materials including less than 0.1 wt % lead. In certain embodiments, the solder material can be tin free. For example a zinc/aluminum based, or bismuth/copper based solder material can be tin free. As used herein, “tin free” refers to solder materials including less than 0.1 wt % tin.

In some embodiments, a zinc/aluminum based solder material may include zinc and aluminum as major components and magnesium and gallium as minor components. In some embodiments, a zinc/aluminum based solder material may include from about 82 to about 96 weight percent zinc, about 3 to about 15 weight percent aluminum, about 0.5 to about 1.5 weight percent magnesium and about 0.5 to about 1.5 weight percent gallium. In particular embodiments, zinc may be present in an amount as little as 82, 84, or 86 percent by weight or as great as 92, 94, or 96 percent by weight, or may be present within any range delimited by any pair of the foregoing values; aluminum may be present in an amount as little as 2, 3, 4 percent by weight, or as great as 5, 7, 10, 12, or 15 percent by weight, or may be present within any range delimited by any pair of the foregoing values; magnesium may be present in an amount as little as 0.5, 0.75, or 0.9 percent by weight, or as great as 1.0, 1.25, or 1.5 percent by weight, or may be present within any range delimited by any pair of the foregoing values; and gallium may be present in an amount as little as 0.5, 0.75, or 0.9 percent by weight or as great as 1.0, 1.25, or 1.5 percent by weight, or may be present within any range delimited by any pair of the foregoing values. In still further embodiments, a zinc/aluminum based solder material may include from about 82 to about 96 weight percent zinc, about 3 to about 15 weight percent aluminum, about 1.0 weight percent magnesium and about 1.0 weight percent gallium.

In some embodiments, dopants such as indium, phosphorous, germanium tin and/or copper may be present in the solder material in a range of about 10 to about 5000 parts per million (or about 0.001 to about 0.5 weight percent). In other embodiments, dopants such as indium, phosphorous, germanium tin and/or copper may be present in the solder material in a range of about 0.001 to about 2.5 percent by weight. In some embodiments, phosphorous may be included in the solder material an amount as little as 10 ppm, 25 ppm, 50 ppm or 100 ppm or as great as 150 ppm, 300 ppm, 500 pm, 1000 ppm or 5000 ppm or may be present within any range delimited by any pair of the foregoing values. In other embodiments, tin may be included in the solder material in an amount as little as 0.1, 0.25, 0.5, or 0.75 percent by weight or as great as 1.0, 1.25, 1.5, 1.75 or 2.0 percent by weight or may be present within any range delimited by any pair of the foregoing values. In still other embodiments, copper may be included in the solder material in an amount as little as 0.1, 0.25, 0.5, or 0.75 or as great as 1.0, 1.25, 1.5, 1.75 or 2.0 percent by weight or may be present within any range delimited by any pair of the foregoing values.

The solder may include only one dopant material, or may include a combination of two or more dopant materials. In some embodiments, the solder composition may include phosphorous and tin as dopant materials. For example, the solder composition may include phosphorous in an amount as little as 10 ppm, 25 ppm, 50 ppm or 100 ppm or as great as 150 ppm, 300 ppm, 500 ppm, 1000 ppm or 5000 ppm or may be present within any range delimited by any pair of the foregoing values; and tin may be present in an amount as little as 0.1, 0.25, 0.5, or 0.75 percent by weight or as great as 1.0, 1.25, 1.5, 1.75 or 2.0 percent by weight or may be present within any range delimited by any pair of the foregoing values. In other embodiments, the solder composition may include phosphorous and copper as dopant materials. For example, the solder composition may include phosphorus in an amount as little as 25 ppm, 50 ppm or 100 ppm or as great as 150 ppm, 300 ppm, 500 ppm, 1000 ppm or 5000 ppm or may be present within any range delimited by any pair of the foregoing values; and copper in an amount as little as 0.1, 0.25, 0.5, or 0.75 percent by weight or as great as 1.0, 1.25, 1.5, 1.75 or 2.0 percent by weight or may be present in a range delimited by any pair of the foregoing values.

In some embodiments, a zinc/aluminum based solder material may consist or consist essentially of about 12 weight percent aluminum, about 1 weight percent magnesium, about 1 weight percent gallium, about 0.5 weight percent dopant, and a balance of zinc. The dopant may be a single material of those listed above, or may be a combination thereof.

In other embodiments, a zinc/aluminum based solder material may consist of about 5 weight percent aluminum, about 1 weight percent magnesium, about 1 weight percent gallium, and a balance of zinc. In still other embodiments, the zinc/aluminum based solder material may consist of about 2 to about 15 weight percent aluminum, about 1 weight percent magnesium, about 1 weight percent gallium, from 50 to 150 ppm phosphorous, from about 0.5 to about 1.5 weight percent tin and a balance of zinc. In still other embodiments, the zinc/aluminum based solder material may consist of about 2 to about 15 weight percent aluminum, about 1 weight percent magnesium, about 1 weight percent gallium, from about 50 ppm to about 150 ppm phosphorous, from about 0.2 to about 0.6 weight percent copper and a balance of zinc.

In some embodiments, a zinc/aluminum based solder material may include zinc and aluminum as major components and germanium as a minor component. In some embodiments, a zinc/aluminum based solder material may include about 78 to about 94 weight percent zinc, about 3 to about 15 weight percent aluminum and about 3 to about 7 weight percent germanium. If included, dopants such as indium, phosphorous, gallium and/or copper may be present in a range of about 0 to about 5000 parts per million (or about 0 to about 0.5 weight percent). The solder composition may include only one dopant material, or may include a combination of two or more dopant materials.

In an embodiment, a zinc/aluminum based solder material may include about 6 weight percent aluminum, about 5 weight percent gallium, about 0.1 weight percent dopant, and a balance of zinc. The dopant may be a single material of those listed above, or may be a combination thereof.

In some embodiments, a bismuth/copper based solder material may include about 88 to about 92 weight percent bismuth and about 8 to about 12 weight percent copper. Dopants such as gallium, indium, phosphorous and/or germanium may be present in a range of about 10 parts per million to about 1000 parts per million (or about 0.001 weight percent to about 0.1 weight percent). The solder composition may include only one dopant material, or may include a combination of two or more dopant materials.

In some embodiments, a bismuth/copper based solder material may consist of about 10 weight percent copper, about 0.1 weight percent dopant, and a balance of bismuth. The dopant may be a single material of those listed above, or may be a combination thereof.

Bismuth/copper based solder materials may exhibit lower melting temperatures and thermal conductivity and thus may be suitable for low power applications while zinc/aluminum based solder materials exhibit higher melting temperatures and thermal conductivity and thus may be suitable for high power applications.

It may be difficult to form a homogenous solder material containing a phosphorous dopant. For example, it may be difficult to mix phosphorous with a solder melt during fabrication. In some embodiments, a solder material may be formed by creating a melt including the base solder material and the phosphorous dopant. In certain embodiments, the phosphorous may be present in an amount from about 10 ppm to about 5000 ppm. In other embodiments, the base solder material may include one or more of the following: zinc, aluminum, bismuth, tin, copper and indium. In certain embodiments, the base solder material and phosphorus dopant can be heated to form a melt under a positive pressure. For example, the melt may be maintained under a positive pressure with the use of an inert gas, such as argon or nitrogen. The positive pressure may avoid vapor loss of the phosphorus dopant. Additionally, the inert gas may be bubbled through the melt to promote mixing of the base solder material and the phosphorous and form a homogenized melt. Following mixing, the melt may be extruded through a die and cast into a billet. In some embodiments, the molten solder may solidify into a solid state in the cast in less than 1 minute. In other embodiments, the molten solder may solidify in the cast in less than 30 seconds, less than 10 seconds, or less than 5 seconds. The rapid cooling of the billet may suppress segregation of the dopant material, such as phosphorous, and may result in a uniform dopant distribution along the billet. For example, the cast billet may have a uniform dopant distribution along the axial direction.

### Example 1

### Zinc/Aluminum Solder Alloys

### I. Formation of Solder Alloy Billets

Zinc/aluminum solder alloys were formed by casting zinc, aluminum, magnesium and gallium in a nitrogen atmosphere into one inch diameter billets.

Zinc/aluminum solder alloys doped with phosphorus and tin were prepared by adding a tin/phosphate alloy containing 95% by weight tin and 5% by weight phosphorous (Sn5P) and the zinc/aluminum solder alloy prepared above to a Rautomead continuous caster. The materials were heated 450-550° C. to form a melt. The melt was maintained under positive pressure. An inert gas was bubbled through the melt until a homogenized melt was achieved. The melt was extruded through a die and cast into one inch diameter billets.

Zinc/aluminum solder alloys doped with phosphorous and copper were prepared by adding a copper/phosphorus alloy containing 85% by weight copper and 15% by weight phosphorous (Cu15P) and the zinc/aluminum solder alloy formed above to a Rautomead continuous caster. A melt was formed by increasing the caster to 800-900° C. The melt was maintained under positive pressure. The melt was extruded through a die and into one inch diameter billets.

Zinc/aluminum solder alloys doped with indium were prepared by forming a melt containing the zinc/aluminum solder alloy prepared above and indium. The melt was cast into one inch diameter billets.

### II. Test Procedures

The solder alloy billets were extruded with a die at 200-300° C. and 1500-2000 pounds per square inch (psi) to form solder wires having a diameter of about 0.762 mm (0.030 inch). The solder wires were wound onto a spool having an inner hub diameter of 51 mm (2 inches) and two outer flanges having diameters of 102 mm (4 inches). Successfully extruded wires could be rolled onto the spool without breaking into two or more pieces.

The melting characteristics of the solder wires were determined by differential scanning calorimetry (“DSC”) using a Perkin Elmer DSC7 machine. The solidus temperature and liquidus temperature were measured. The melting temperature range was calculated as the difference between the liquidus temperature and the solidus temperature.

Elongation of the solder wires were determined with an Instron 4465 machine at room temperature according to ASTM E8, entitled “Standard Test Methods for Tension Testing of Metallic Materials.”

The low angle breakage rate and the high angle breakage rate for the solder wires were determined at room temperature to investigate the ductility of the wires. For each breakage rate test, a wire was bent around the inner hub of an empty spool and it was recorded whether the wire broke after one rotation on the inner hub. The test was conducted a plurality of times and percent breakage for each sample was calculated.

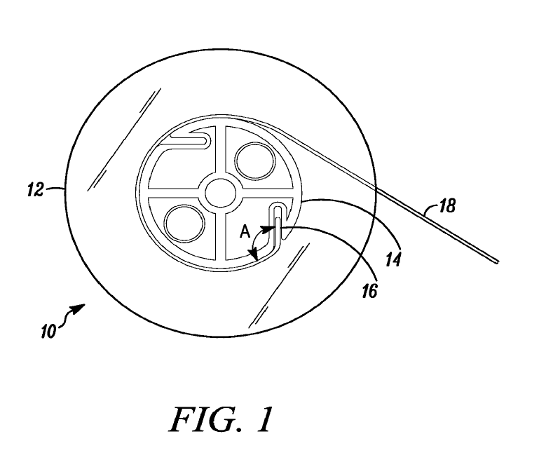

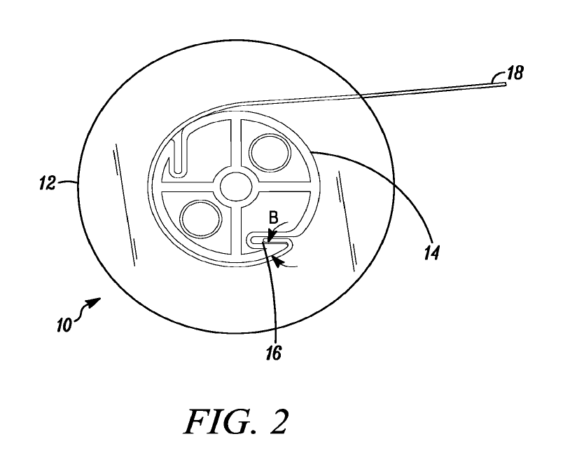

FIG. 1 illustrates the experimental setup for a high angle breakage rate test. As shown, spool 10 includes flanges 12, inner hub 14 and slot 16 Inner hub 14 is positioned between parallel flanges 12, creating a space there between Inner hub 14 has a diameter of 51 mm and flanges 12 have diameters of 102 mm. Slot 16 is formed in inner hub 14. One end of wire 18 is inserted into slot 16 and wire 18 is rolled onto inner hub 14. As shown in FIG. 1, the end of wire 18 in hole 16 forms an angle A with the wire 18 rolled in inner hub 14. Angle A is greater than 90°. FIG. 2 shows the experimental setup for a low angle breakage rate test. Again, one end of wire 18 is inserted into slot 16. In the low angle bend test, the end of wire 18 in slot 16 forms an angle B with the wire 18 rolled in inner hub 14. Angle B is less than 90°.

The solder wetting properties were determined using an ASM SD890A die bonder at 410° C. using forming gas containing 95 vol % nitrogen and 5 vol % hydrogen. The solder wire was fed to a hot copper lead frame, causing the solder wire to melt and form a dot on the lead frame. The size (e.g., diameter) of the dot was measured. The size of the dot corresponds to the wettability of the solder wire, with a larger dot size corresponding to better wetting.

### III. Results

The billets were extruded through a die to form a 0.030 inch diameter wire and were rolled onto a spool. Table 1 presents the composition of wires that were successfully extruded and formed into a coil on the spool. The wires of Table 2 resulted in a brittle coil or could not be formed into a coil.

TABLE 1
Compositions successfully extruded into wires and coiled

| Sam- | Al | Mg | Ga | Sn | Cu | P | Zinc |
|---|---|---|---|---|---|---|---|
| ple | (wt %) | (wt %) | (wt %) | (wt %) | (wt %) | (wt %) | (wt %) |
| 1 | 4.40 | 0.97 | 0.10 | | | | bal |
| 2 | 4.38 | 0.96 | 0.22 | | | | bal |
| 3 | 4.38 | 0.93 | 0.41 | | | | bal |
| 4 | 4.38 | 0.94 | 0.67 | | | | bal |
| 5 | 4.35 | 0.95 | 0.87 | | | | bal |
| 6 | 4.40 | 0.97 | 1.11 | | | | bal |
| 7 | 4.34 | 0.95 | 1.29 | | | | bal |
| 11 | 4.38 | 0.10 | 0.87 | | | | bal |
| 12 | 4.42 | 0.26 | 0.87 | | | | bal |
| 13 | 4.42 | 0.48 | 0.87 | | | | bal |
| 14 | 4.40 | 0.74 | 0.87 | | | | bal |
| 15 | 4.38 | 1.26 | 0.87 | | | | bal |
| 16 | 4.42 | 1.46 | 0.88 | | | | bal |
| 17 | 4.40 | 1.72 | 0.88 | | | | bal |
| 24 | 4.5 | 1.0 | 1.0 | 0.59 | — | 0.0120 | bal |
| 25 | 4.5 | 1.0 | 1.0 | 1.38 | — | 0.0200 | bal |
| 26 | 4.5 | 1.0 | 1.0 | 1.92 | — | 0.0250 | bal |
| 27 | 4.5 | 1.0 | 1.0 | — | 0.15 | 0.0100 | bal |
| 28 | 4.5 | 1.0 | 1.0 | — | 0.15 | 0.0170 | bal |
| 29 | 4.5 | 1.0 | 1.0 | — | 0.12 | 0.0060 | bal |

TABLE 2
Composition not successfully extruded and coiled

| | Al | Mg | Ga | In | Zinc | |
|---|---|---|---|---|---|---|
| Sample | (wt %) | (wt %) | (wt %) | (wt %) | (wt %) | Coil formation |
| 8 | 4.36 | 0.96 | 1.53 | | bal | brittle coil |
| 9 | 4.39 | 0.94 | 1.72 | | bal | No coil |
| 10 | 4.35 | 0.95 | 2.15 | | bal | No coil |
| 18 | 4.38 | 1.95 | 0.88 | | bal | brittle coil |
| 19 | 4.43 | 2.44 | 0.88 | | bal | No coil |
| 20 | 4.44 | 1.46 | 1.32 | | bal | brittle coil |
| 21 | 4.40 | 1.44 | 1.73 | | bal | No coil |
| 22 | 4.39 | 1.92 | 1.31 | | bal | No coil |
| 23 | 4.37 | 1.92 | 1.73 | | bal | No coil |
| 30 | 4.5 | 1.0 | 1.0 | 0.5 | bal | No coil |
| 31 | 4.5 | 1.0 | 1.0 | 1.0 | bal | No coil |
| 32 | 4.5 | 1.0 | 1.0 | 1.5 | bal | No coil |

As shown in Tables 1 and 2, when the gallium content is greater than 1.5% by weight, a brittle coil was formed, and no coil could be formed with the gallium content was greater than 1.7% by weight. In particular, the wire could not be successfully coiled onto the take-up spool following the final cold wire draw. Similarly, when the magnesium content was greater than 1.5% by weight, a brittle coil was formed.

Coils could not be successfully formed when the zinc/aluminum alloy was doped with indium (see e.g., Samples 30, 31, 32).

The melting characteristics of the extruded zinc/aluminum alloy wires are presented in Table 3. The melt characteristics of the extruded doped zinc/aluminum alloy wires are presented in Table 4.

TABLE 3
Melting characteristics of zinc/aluminum alloy wires

| | | | | | Soli- | Liqui- | Melt- |
|---|---|---|---|---|---|---|---|
| | | | | | dus | dus | ing |
| Sam- | Al | Mg | Ga | Zinc | Temp | Temp | Range |
| ple | (wt %) | (wt %) | (wt %) | (wt %) | (C.) | (C.) | (C.) |
| 1 | 4.40 | 0.97 | 0.10 | balance | 334.4 | 364.7 | 30.3 |
| 2 | 4.38 | 0.96 | 0.22 | balance | 333.1 | 364.7 | 31.6 |
| 3 | 4.38 | 0.93 | 0.41 | balance | 329.7 | 363 | 33.3 |
| 4 | 4.38 | 0.94 | 0.67 | balance | 322.1 | 363 | 40.9 |
| 5 | 4.35 | 0.95 | 0.87 | balance | 324.1 | 361.9 | 37.8 |
| 6 | 4.40 | 0.97 | 1.11 | balance | 320.4 | 360.9 | 40.5 |
| 7 | 4.34 | 0.95 | 1.29 | balance | 330.1 | 360.2 | 30.1 |
| 8 | 4.36 | 0.96 | 1.53 | balance | 321.5 | 359.1 | 37.6 |
| 9 | 4.39 | 0.94 | 1.72 | balance | 322.1 | 359.8 | 37.7 |
| 10 | 4.35 | 0.95 | 2.15 | balance | 314 | 358.8 | 44.8 |
| 11 | 4.38 | 0.10 | 0.87 | balance | 361 | 384 | 23 |
| 12 | 4.42 | 0.26 | 0.87 | balance | 353 | 380 | 27 |
| 13 | 4.42 | 0.48 | 0.87 | balance | 323.7 | 368.5 | 44.8 |
| 14 | 4.40 | 0.74 | 0.87 | balance | 323.1 | 364.8 | 41.7 |
| 15 | 4.38 | 1.26 | 0.87 | balance | 323.4 | 358.2 | 34.8 |
| 16 | 4.42 | 1.46 | 0.88 | balance | 323.7 | 355.6 | 31.9 |
| 17 | 4.40 | 1.72 | 0.88 | balance | 325.3 | 351.1 | 25.8 |
| 18 | 4.38 | 1.95 | 0.88 | balance | 326.1 | 346.7 | 20.6 |
| 19 | 4.43 | 2.44 | 0.88 | balance | 325.1 | 350 | 24.9 |
| 20 | 4.44 | 1.46 | 1.32 | balance | 319.4 | 353.7 | 34.3 |
| 21 | 4.40 | 1.44 | 1.73 | balance | 314.4 | 353.1 | 38.7 |
| 22 | 4.39 | 1.92 | 1.31 | balance | 319 | 346.2 | 27.2 |
| 23 | 4.37 | 1.92 | 1.73 | balance | 313.7 | 343.6 | 29.9 |

TABLE 4
Melting characteristics of doped zinc/aluminum alloy wires

| Sam- | Sn | Cu | P | Solidus | Liquidus | Melting |
|---|---|---|---|---|---|---|
| ple | (wt %) | (wt %) | (wt %) | Temp (C.) | Temp (C.) | Range (C.) |
| 24 | 0.59 | — | 0.012 | 310.7 | 362.8 | 52.1 |
| 25 | 1.38 | — | 0.020 | 309.1 | 360.3 | 51.2 |
| 26 | 1.92 | — | 0.025 | 304.7 | 358.6 | 53.9 |
| 27 | — | 0.15 | 0.010 | 324.7 | 362.5 | 37.8 |
| 28 | — | 0.15 | 0.017 | 324.4 | 363 | 38.6 |
| 29 | — | 0.12 | 0.006 | 324 | 364.4 | 40.4 |

As shown in Table 3, the solidus temperature and liquidus temperature generally decreased as the amount of gallium increased. Similarity, the solidus temperature and liquidus temperature generally decreased as the amount of magnesium increased.

It is noted that the melting range is narrower when gallium content was less than 0.5 wt % (see Samples 1 and 2 compared to Samples 4 and 5). However, the Solidus temperature and liquidus temperature of Samples 1 and 2 were greater than Samples 4 and 5.

The melting range is also narrower when the magnesium content was less than 0.5 wt % (see Samples 11 and 12 compared to Sample 14 and 6). The solidus temperature and liquidus of Samples 11 and 12 were greater than Samples 14 and 6, thus a greater amount of heat is required for soldering Samples 11 and 12.

As shown in Table 4, doping with tin/phosphorous decreased the solidus temperature (e.g., compare Sample 24 to Sample 5). Doping with copper/phosphorous did not appear to have a significant impact on the solidus temperature or liquidus temperature (e.g., compare Sample 27 to Sample 5).

The mechanical properties of the extruded zinc/aluminum alloy wires are presented in Table 5. The mechanical properties of the extruded doped zinc/aluminum alloy wires are presented in Table 6.

TABLE 5
Mechanical properties of zinc/aluminum alloy wires

| | | | | | Elongation |
|---|---|---|---|---|---|
| Sample | Al (wt %) | Mg (wt %) | Ga (wt %) | Zinc (wt %) | (%) |
| 1 | 4.40 | 0.97 | 0.10 | balance | 6.0 |
| 2 | 4.38 | 0.96 | 0.22 | balance | 5.8 |
| 3 | 4.38 | 0.93 | 0.41 | balance | 15.8 |
| 4 | 4.38 | 0.94 | 0.67 | balance | 8.5 |
| 5 | 4.35 | 0.95 | 0.87 | balance | 13.5 |
| 6 | 4.40 | 0.97 | 1.11 | balance | 3.6 |
| 7 | 4.34 | 0.95 | 1.29 | balance | 1.5 |
| 8 | 4.36 | 0.96 | 1.53 | balance | 1.3 |
| 9 | 4.39 | 0.94 | 1.72 | balance | 4.8 |
| 10 | 4.35 | 0.95 | 2.15 | balance | 4.2 |
| 11 | 4.38 | 0.10 | 0.87 | balance | 42.6 |
| 12 | 4.42 | 0.26 | 0.87 | balance | 28.4 |
| 13 | 4.42 | 0.48 | 0.87 | balance | 29.9 |
| 14 | 4.40 | 0.74 | 0.87 | balance | 22.9 |
| 15 | 4.38 | 1.26 | 0.87 | balance | 4.6 |
| 16 | 4.42 | 1.46 | 0.88 | balance | 1.6 |
| 17 | 4.40 | 1.72 | 0.88 | balance | 0.8 |
| 18 | 4.38 | 1.95 | 0.88 | balance | 1.3 |
| 19 | 4.43 | 2.44 | 0.88 | balance | 1.3 |
| 20 | 4.44 | 1.46 | 1.32 | balance | 0.5 |
| 21 | 4.40 | 1.44 | 1.73 | balance | 1.8 |
| 22 | 4.39 | 1.92 | 1.31 | balance | 1.3 |
| 23 | 4.37 | 1.92 | 1.73 | balance | 1.0 |

TABLE 6
Mechanical properties of doped zinc/aluminum alloy wires

| | | | | Elongation |
|---|---|---|---|---|
| Sample | Sn (wt %) | Cu (wt %) | P (wt %) | (%) |
| 24 | 0.59 | — | 0.012 | 10.0 |
| 25 | 1.38 | — | 0.020 | 3.9 |
| 26 | 1.92 | — | 0.025 | — |
| 27 | — | 0.15 | 0.010 | 1.7 |
| 28 | — | 0.15 | 0.017 | 3.8 |
| 29 | — | 0.12 | 0.006 | 5.8 |

As shown in Table 5, solder material containing above 1.0 wt % gallium had a significant reduction in elongation. Solder material containing below 0.5 wt % gallium had relatively low elongation (e.g. less than 7% elongation). Solder material containing above 1.0 wt % magnesium had a significant reduction in elongation, below

As shown in Table 6, the inclusion of tin/phosphorous or copper/phosphorous dopant reduced the elongation of the solder material (e.g., compare Sample 24 to Sample 5 and Sample 27 to Sample 5). The elongation of Sample 26 was not determined.

In some embodiments, a wire with acceptable ductility has a high angle breakage rate (Bend BR-HA) of 0% and a low angle breakage rate (Bend BR-LA) less than 30%. The wire ductility results of satisfactory wires are presented in Table 7. Sample wires not meeting the desired high angle and low angle breakage rates are presented in Table 8.

TABLE 7
Wires with satisfactory breakage rates

| Sample | Bend BR-HA | Bend BR-LA |
|---|---|---|
| 1 | 0% | 0% |
| 2 | 0% | 0% |
| 3 | 0% | 0% |
| 4 | 0% | 0% |
| 5 | 0% | 0% |
| 11 | 0% | 0% |
| 12 | 0% | 0% |
| 13 | 0% | 0% |
| 14 | 0% | 0% |
| 24 | 0% | 0% |
| 25 | 0% | 20% |
| 28 | 0% | 20% |

TABLE 8
Wires with unsatisfactory breakage rates

| Sample | Bend BR-HA | Bend BR-LA |
|---|---|---|
| 6 | 0% | 40% |
| 7 | 0% | 100% |
| 8 | 0% | 100% |
| 9 | 20% | 100% |
| 10 | 40% | 100% |
| 15 | 0% | 80% |
| 16 | 0% | 100% |
| 17 | 0% | 100% |
| 18 | 0% | 100% |
| 19 | 0% | 100% |
| 20 | 100% | 100% |
| 21 | 100% | 100% |
| 22 | 100% | 100% |
| 23 | 100% | 100% |
| 26 | 100% | 100% |
| 27 | 0% | 50% |
| 29 | 0% | 40% |

As shown in Tables 6 and 7, when the gallium content is greater than 1.0% by weight, the low angle breakage rate was greater than 30%. Similarly, when the magnesium content was greater than 1.0% by weight, the low angle breakage rate was greater than 30%.

The solder wetting properties are presented in Table 9, where a larger dot wet size indicates increased wetting properties.

TABLE 9
Solder wetting properties of
zinc/aluminum and doped zinc/aluminum wires

| Sample | Dot Wet - Size (mm) |
|---|---|
| 1 | 2.62 |
| 2 | 2.79 |
| 3 | 2.80 |
| 4 | 2.88 |
| 5 | 2.74 |
| 6 | 2.71 |
| 7 | 2.72 |
| 8 | 2.68 |
| 9 | — |
| 10 | — |
| 11 | 2.62 |
| 12 | 2.72 |
| 13 | 2.76 |
| 14 | 2.75 |
| 15 | 2.72 |
| 16 | 2.86 |
| 17 | 2.72 |
| 18 | 2.77 |
| 19 | — |
| 20 | — |
| 21 | — |
| 22 | — |
| 23 | — |
| 24 | 2.60 |
| 25 | 2.62 |
| 26 | — |
| 27 | 2.87 |
| 28 | 2.87 |
| 29 | 2.87 |

Samples 9, 10, 19, 20, 21, 22, 23 and 26 were not tested. As shown in Table 9, additions of gallium up to about 0.75 wt % increased wetting, after which the wetting decreased. Additionally, additions of magnesium generally increased wetting.

Additions of tin/phosphorous dopant slightly reduced wetting and additions of copper/phosphorus dopant increased wetting.

### Example 2

### Comparison of Solder Materials

### I. Formation of Solder Wires

A lead solder, bismuth solder and zinc aluminum solder were formed by creating a melt of the respective components as indicated below, casting into billets and extruding the billets through a die to form solder wire having a diameter of 0.762 mm (0.030 inch).

Sample 33: 92.5 wt % lead, 5 wt % indium, 2.5 wt % silver

Sample 34: 89.9 wt % bismuth, 10 wt % copper, 0.1 wt % gallium

Sample 35: 93.5 wt % zinc, 4.5 wt % aluminum, 1 wt % magnesium, 1 wt % gallium

### II. Test Procedures

Solidus temperature and elongation were determined as described for Example 1.

A thermal analysis of the solder compositions were determined by differential scanning calorimetry (“DSC”) using a Perkin Elmer DSC7 machine.

The sample diffusivity of the solder materials was determined using a Nanoflash machine. The thermal conductivity of each solder material was calculated using the diffusivity value.

The coefficient of thermal expansion (CTE) was calculated for each solder material. The sample length change of each material was measured with a thermal mechanical analyzer and calculated against temperature to determine the CTE.

The electrical resistance of the solder materials was determined by measuring the sample resistance under a given voltage at a given length range using an electrical meter. The resistivity was calculated using the resistance and the sample cross sectional area.

A die bond test was conducted with dummy dies on an ASM die bonder Lotus-SD with solder writing capability. The lead frames used ASM inhouse TO220 bare copper and nickel-plated copper. The dummy die size was 2×3 mm with titanium, nickel, silver (Ti/Ni/Ag) back side metallization. A forming gas containing 95 vol % nitrogen and 5 vol % hydrogen was used with the following zone settings: 5 liters per minute (LPM) preheat zone 1, 5 LPM preheat zone 2, 5 LPM preheat zone 3, 2 LMP dispense zone, 2 LPM spank zone, 2 LPM bond zone, and 2 LMP cooling zone. The bond zone time was 700 milliseconds, the solder dispense rate was 2,200 microns with 9-line “z” pattern. The temperature setting for the zones was varied.

Die shear was measured with a die shear tester. A die was pushed along the die edge until there was die crack or the substrate was shorn off. The shear force was recorded by the die shear tester.

Die tilt was determined by measuring the four corners of the bonded die with a micrometer. The die tilt was calculated as the maximum difference between the readings.

Bond line was determined by measuring the die thickness, bonded die thickness, and substrate thickness with a micrometer. The bonded line thickness was calculated by formula (1).

bonded line thickness=bonded die thickness−die thickness−substrate thickness (1)

### III. Results

The physical conditions of the solder materials are presented in Table 10.

TABLE 10
Solder physical properties

| | Solidus | Elongation | Therm Cond | CTE | Elec Res |
|---|---|---|---|---|---|
| Sample | Temp (C.) | (%) | (W/mK) | (ppm/K) | (μΩ · cm) |
| 33 | 300 | 57.3 | 25.0 | 25.0 | 31.0 |
| 34 | 271 | 52.1 | 17.1 | 12.1 | 61.1 |
| 35 | 337 | 33.8 | 85.4 | 26.1 | 6.4 |

The solidus temperature and the thermal conductivity (theme cond) of the bismuth solder (Sample 34) are lower than the lead solder (Sample 33), suggesting that the bismuth solder should be used for low power device applications where there is limited post die attach thermal process and/or no requirement for high thermal conductivity.

The zinc solder (Sample 35) has a higher solidus temperature and thermal conductivity than the lead solder (Sample 33), which enables use of the zinc solder for high power and high temperature applications. The low elongation of the bismuth solder (Sample 34) and the zinc solder (Sample 35) as compared to the lead solder (Sample 33) makes the solder materials less flexible to absorb and relieve thermal stress after die attach.

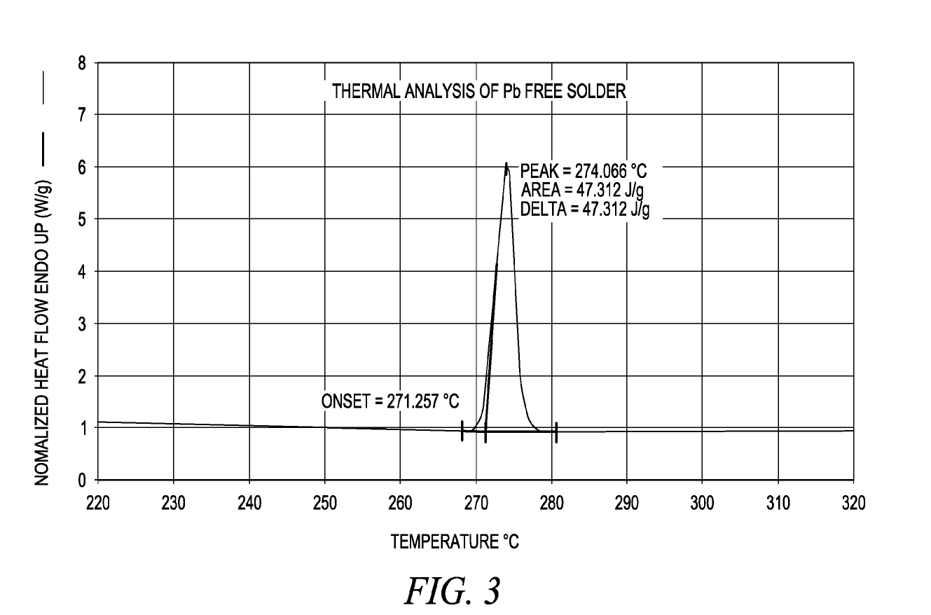

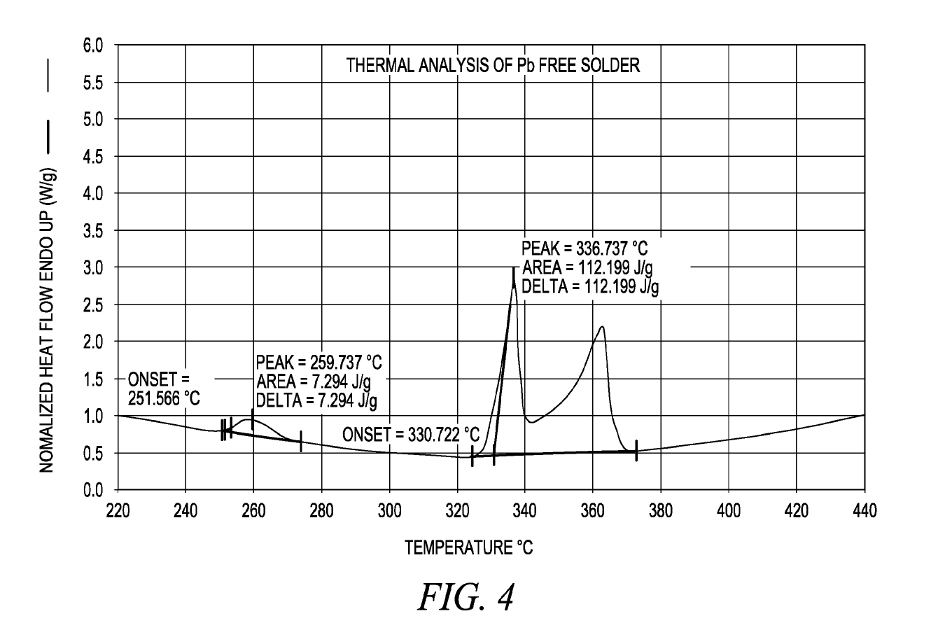

A thermal analysis of Samples 34 and 35 are presented in FIGS. 3 and 4, respectively. As illustrated in FIG. 3, Sample 34 had a solidus temperature of 271° C. Since copper does not melt until it reaches temperatures above 700° C., the alloy at the 360-400° C. die attach temperature is a composite alloy. The wetting and soldering may be primarily warranted by molten bismuth of Sample 34. Additionally, the micrometer size copper particles at the die attach temperature may help control the spread of the molten bismuth on the substrate during die attach and may provide the required thermal conductivity after device build.

As illustrated in FIG. 4, Sample 35 had a solidus temperature of 337° C. A low temperature peak at 272° C. is a solid reaction and has no effect on solder melting characteristics.

The die bond test was conducted and the temperature of various zones were adjusted to achieve an even wet, die bond. The process conditions and results are presented in Table 11, where LF indicates the lead frame, PH1 is the temperature of pre-heating zone 1, PH2/3 is the temperature of pre-heating zones 2 and 3, D/S/B is the temperature of the dispense, spank, and bond zones and Cool is the temperature of the cooling zone.

TABLE 11
Die Attach Process Conditions

| Sam- | | PH1 | PH2/3 | D/S/B | Cool | |
|---|---|---|---|---|---|---|
| ple | LF | (C.) | (C.) | (C.) | (C.) | Note |
| 33-1 | Cu | 300 | 360 | 360 | 300 | uneven wet, no die bond |
| 33-2 | Cu | 320 | 380 | 360 | 300 | even wet, die bond |
| | | | | | | reference |
| 34-1 | Cu | 320 | 400 | 360 | 320 | uneven wet |
| 34-2 | Cu | 330 | 400 | 370 | 320 | uneven wet |
| 34-3 | Cu | 340 | 400 | 380 | 320 | even wet, die bond |
| | | | | | | comparable to 30-2 |
| 34-4 | Ni | 340 | 400 | 380 | 320 | uneven wet |
| 34-5 | Ni | 340 | 400 | 390 | 320 | uneven wet |
| 34-6 | Ni | 340 | 400 | 400 | 320 | even wet, die bond |
| | | | | | | comparable to 30-2 |
| 35-1 | Cu | 320 | 380 | 360 | 320 | uneven wet |
| 35-2 | Cu | 320 | 400 | 380 | 320 | uneven wet, die bond not as |
| | | | | | | good as 30-2 |
| 35-3 | Cu | 340 | 400 | 400 | 340 | uneven wet |
| 35-4 | Cu | 340 | 400 | 380 | 320 | uneven wet, double Z-9 |
| | | | | | | pattern |
| 35-5 | Cu | 340 | 400 | 380 | 320 | uneven wet, add 50 um |
| | | | | | | scrub |
| 35-6 | Cu | 340 | 400 | 380 | 320 | uneven wet, add 150 um |
| | | | | | | scrub |
| 35-7 | Ni | 320 | 400 | 380 | 320 | even wet, die bond |
| | | | | | | comparable to 30-2 |

The die bond samples were tested for die shear. The results are presented in Table 12.

TABLE 12
Die Shear Results

| Sample | Mean Force (Kgf) | Stdev (Kgf) | Failure Mode |
|---|---|---|---|
| 34 on Cu | 9.80 | 0.55 | Cohesive |
| 34 on Ni | 10.06 | 0.57 | Cohesive |
| 35 on Cu | 9.59 | 0.33 | Cohesive |
| 35 on Ni | 8.52 | 0.18 | Cohesive |

All samples showed adequate sheer force and cohesive failure mode.

The die bond samples were tested for tilt and bond line thickness. The results are presented in Table 13.

TABLE 13
Die tilt and bond line thickness results

| | Die Tilt | | Bond Line Thickness | |
|---|---|---|---|---|
| Sample | Mean (mil) | Stdev (mil) | Mean (mil) | Stdev (mil) |
| 34 on Cu | 0.73 | 0.26 | 1.49 | 0.34 |
| 34 on Ni | 0.66 | 0.15 | 1.28 | 0.27 |
| 35 on Cu | 0.56 | 0.31 | 1.71 | 0.51 |
| 35 on Ni | 0.53 | 0.32 | 1.70 | 0.27 |

All samples showed comparable values in general die attach applications.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

We claim:

1. A solder composition comprising:
about 82 to 96 weight percent zinc;
about 3 to about 15 weight percent aluminum;
about 0.5 to about 1.5 weight percent magnesium; and
about 0.5 to about 1.5 weight percent gallium.

2. The solder composition of claim 1, comprising:
about 0.75 to about 1.25 weight percent magnesium; and
about 0.75 to about 1.25 weight percent gallium.

3. The solder composition of claim 1, comprising:
about 1.0 weight percent magnesium; and
about 1.0 weight percent gallium.

4. The solder composition of claim 1, and further comprising:
about 0.1 to about 2.0 weight percent tin.

5. The solder composition of claim 1, and further comprising at least one dopant present in an amount from about 0.001 to about 0.5 weight percent.

6. The solder composition of claim 5, wherein the at least one dopant comprises one or more of indium, phosphorous, germanium or copper.

7. The solder composition of claim 5, wherein the dopant comprises phosphorous and at least one member selected from the group consisting of tin and copper.

8. The solder composition of claim 1, and further comprising:
about 10 ppm to about 1000 ppm phosphorous; and
about 0.1 to about 2 weight percent tin.

9. The solder composition of claim 1, and further comprising:
about 25 ppm to about 300 ppm phosphorous; and
about 0.5 to about 1.5 weight percent tin.

10. The solder composition of claim 1, and further comprising:
about 25 ppm to about 300 ppm phosphorous; and
about 0.1 to about 1 percent copper.

11. The solder composition of claim 1, and further comprising:
less than about 0.1 weight percent lead.

12. The solder composition of claim 1, and further comprising:
less than about 0.1 weight percent tin.

13. The solder composition of claim 1, wherein the solder composition consists of zinc, aluminum, gallium, and magnesium.

14. The solder composition of claim 1, wherein the solder composition consists of zinc, aluminum, gallium, magnesium, tin and phosphorous.

15. The solder composition of claim 1, wherein the solder composition consists of zinc, aluminum, gallium, magnesium and at least one dopant.

16. The solder composition of claim 1, wherein the solder composition is a solder wire.

17. The solder composition of claim 16, wherein the solder wire has a diameter of less than about 1 millimeter.

18. A method of forming a phosphorous doped solder, the method comprising:
producing a melt under positive pressure with an inert gas; and
forming the melt into a billet, wherein the melt comprises a solder material and phosphorus in an amount between about 10 ppm and about 5000 ppm.

19. The method of claim 18, wherein the solder material comprises at least one member selected from the group consisting of zinc, aluminum, bismuth, tin, copper and indium.

20. The method of claim 18, further comprising, between the producing and forming steps, the additional step of bubbling an inert gas through the melt.
